(19) United States
(12) Patent Application Publication
(10) Pub. No.: US 2020/0053537 A1
(43) Pub. Date: Feb. 13, 2020

(54) METHOD AND DEVICE FOR GENERATING AN EMERGENCY CALL FOR A VEHICLE

(71) Applicant: Robert Bosch GmbH, Stuttgart (DE)

(72) Inventor: Martin Klein, Brackenheim (DE)

(21) Appl. No.: 16/341,678

(22) PCT Filed: Aug. 8, 2017
(86) PCT No.: PCT/EP2017/070081

§ 371 Date: Apr. 12, 2019

(30) Foreign Application Priority Data
Oct. 19, 2016 (DE) 10 2016 220 479.3

(51) Int. Cl. H04W 4/90; H04W 4/20; G08G 1/16; H04M 1/725; G06K 9/00; H04W 4/40

(52) U.S. Cl. CPC H04W 4/90; H04W 4/20; H04W 4/40; H04M 1/72538; G06K 9/00805; G08G 1/162

(57) ABSTRACT

A method for generating an emergency call for a vehicle includes: reading in, from at least one collision sensor, a collision signal that represents at least one collision characteristic of a collision of the vehicle with the at least one collision object; reading in from at least one environment sensor of the vehicle an environment-sensor signal that represents an environment of the vehicle including the at least one collision object; ascertaining at least one object property of the at least one collision object using the environment-sensor signal; generating an emergency-call signal using the at least one collision characteristic and the at least one object property; and supplying the emergency-call signal for output to a transmitter device of the vehicle.

### CROSS-REFERENCE TO RELATED APPLICATIONS

The present application is the national stage of International Pat. App. No. PCT/EP2017/070081 filed Aug. 8, 2017, and claims priority under 35 U.S.C. § 119 to DE 10 2016 220 479.3, filed in the Federal Republic of Germany on Oct. 19, 2016, the content of each of which are incorporated herein by reference in their entireties.

### BACKGROUND

So-called eCall emergency call systems are to be installed in new vehicles throughout Europe. Such emergency call systems are able to output an emergency call, in particular automatically, starting at a certain accident severity. The German document DE 10 2013 005 824 A1 describes an emergency-call system for a vehicle, in which there are two emergency-call transmitter devices for outputting two emergency calls to two receiving stations via a mobile radio network and using short-range communications technology.

### SUMMARY

Against this background, example embodiments of the present invention are directed to a method for generating an emergency call for a vehicle, a corresponding device, as well as a corresponding computer program.

According to example embodiments, it is possible to consider and use also acquired information pertaining to an environment of the vehicle, in particular in connection with an automatic or automated emergency call for a vehicle during a collision. Such an emergency call can thus include not only information about the vehicle itself, for instance, but also information about collision partners, collision opponents, or the like. In other words, it is possible to evaluate in particular environment sensor data of a vehicle and to take it into account in the information transmitted by such an emergency call.

According to example embodiments, for example, an upgrading of what is known as an eCall functionality can be achieved using information from at least one environment sensor of the vehicle. Such a consideration of data from at least one environment sensor for an automatic vehicle-emergency call or an eCall system makes it possible to output a reliable, precise, sound, and needs-oriented emergency call. Emergency measures are able to be initiated in a timely and need-based manner.

According to an example embodiment, a method for generating an emergency call for a vehicle includes: reading in a collision signal from an interface to at least one collision sensor of the vehicle and an environment-sensor signal from an interface to at least one environment sensor of the vehicle, the collision signal representing at least one collision characteristic of a collision of the vehicle with at least one collision object, and the environment sensor signal representing an environment of the vehicle that includes the at least one collision object; ascertaining at least one object property of the at least one collision object using the environment-sensor signal;

generating an emergency-call signal using the at least one collision characteristic and the at least one object property; and supplying the emergency-call signal for output to a transmitter device of the vehicle.

For example, this method can be implemented in software or hardware or in a mixed form of software and hardware, e.g., in a control unit. The at least one collision sensor is able to be developed as an acceleration sensor, a pressure sensor, or a similar device. The at least one collision characteristic can represent an impact of the vehicle on the at least one collision object, a relative velocity between the vehicle and the at least one collision object, a velocity of the vehicle, a collision angle relative to the vehicle, an impact area of the at least one collision object on the vehicle and, additionally or alternatively, at least one further collision characteristic. The at least one collision object can be another vehicle, a pedestrian, or a stationary object or obstacle. A transmitter device can be developed to transmit the emergency-call signal to at least one device outside the vehicle in a wireless manner, via a radio interface or the like. Furthermore, the method allows for a response to a request of an emergency call or for arriving at a decision about the need for an emergency call utilizing the collision signal.

According to an example embodiment, in the step of generating, an emergency-call signal is able to be generated, which represents emergency data as a function of the at least one collision characteristic and, additionally or alternatively, the at least one object property. The emergency data can allow for a notification of emergency personnel. The emergency data can also be dependent on the at least one object property of the at least one collision object. Such a development offers an advantage that a reliable emergency call appropriate to the situation is able to be generated, whose emergency data can differ as a function of the collision object.

In the step of generating, it is also possible to generate an emergency-call signal that represents as the emergency data an estimated value for a number of persons injured by the collision, an estimated value for an injury degree of persons injured by the collision, an estimated value for damage to the vehicle and, additionally or alternatively, an estimated value for damage to the at least one collision object. In the step of ascertaining, an estimated and, additionally or alternatively, a maximum occupancy of the at least one collision object by persons and, additionally or alternatively, damage to the at least one collision object as the at least one object property can be ascertained. Such an example embodiment is advantageous insofar as an initiation of emergency measures that are appropriate for the consequences of the collision is able to be accelerated.

Furthermore, in the step of reading in, at least one image signal as an environment-sensor signal can be read in from an interface to a vehicle camera of the vehicle. In the step of ascertaining, the at least one object property is able to be ascertained as an optically detectable object property utilizing the image signal. In the step of reading in, it is optionally also possible to read in vehicle-sensor data from an interface to at least one vehicle sensor and to take the data into account in subsequent method steps, such as information about a seat occupancy in the vehicle or the like. Such a example embodiment offers an advantage that image data of the environment can be evaluated in a reliable and accurate manner and that inferences derived therefrom can be taken into account for the emergency call.

In addition, in the step of ascertaining, the at least one collision object can be classified so that an object class can be ascertained as the object property. For instance, the object class can represent another vehicle, a type of other vehicle, a pedestrian, or an obstacle. Such an example embodiment is advantageous insofar as information about the at least one collision object is able to be obtained in a rapid and reliable manner.

According to an example embodiment of the present invention, a device is configured to carry out, actuate, or implement the steps of a variant of a method introduced here in corresponding devices. This example embodiment variant of the present invention in the form of a device is also able to achieve the object that forms the basis of the present invention in a rapid and efficient manner.

For this purpose, the device can have at least one processing unit for processing signals or data, at least one memory unit for storing signals or data, at least one interface to a sensor or an actuator for reading in sensor signals from the sensor or for outputting data or control signals to the actuator, and/or at least one communications interface for reading in or outputting data which are embedded in a communications protocol. The processing unit, for example, can be a signal processor, a microcontroller, or the like, and the memory unit can be a flash memory, an EEPROM, or a magnetic memory unit. The communications interface can be developed to read in or output data in a wireless and/or a line-conducted manner, and a communications interface, which is able to read in or output wire-conducted data, is able to read in these data, e.g., electrically or optically, from a corresponding data-transmission line, or to output these data onto a corresponding data-transmission line.

In this instance, a device can be understood as an electrical device that processes sensor signals and outputs control and/or data signals as a function thereof. The device can have an interface, which could be developed in hardware and/or software. In the case of a hardware development, the interfaces can be part of what is known as a system ASIC, for instance, which includes a variety of different functions of the device. However, it is also possible that the interfaces are discrete, integrated switching circuits or are at least partially made up of discrete components. In the case of a software development, the interfaces can be software modules, which are provided on a microcontroller in addition to other software modules.

In an example embodiment, a control of an emergency-call system of the vehicle is carried out by the device. To this end, the device can access sensor signals such as collision signals or environment-sensor signals, for example. An actuation of a transmitter device for the transmission of the emergency-call signal is able to be carried out using the emergency-call signal.

An example embodiment of the present invention is directed to a computer-program product or a computer program having program code, which is able to be stored on a machine-readable carrier or a memory medium such as a semiconductor memory, a hard disk memory, or an optical memory and which is used for carrying out, implementing, and/or actuating the steps of the present method according to one of the previously described example embodiments, in particular when the program product or program is executed on a computer or a device.

Example embodiments of the approach introduced here are shown in the drawing and described in greater detail in the following description.

### BRIEF DESCRIPTION OF THE DRAWINGS

FIG. 1 a schematic illustration of a device according to an example embodiment of the present invention in a vehicle during a collision.

FIG. 2 a flowchart of a method for generating according to an example embodiment of the present invention.

### DETAILED DESCRIPTION

In the following description of advantageous example embodiments of the present invention, identical or similar reference numerals are used for the elements that are shown in the figures and have a similar effect, and a repeated description of these elements is dispensed with.

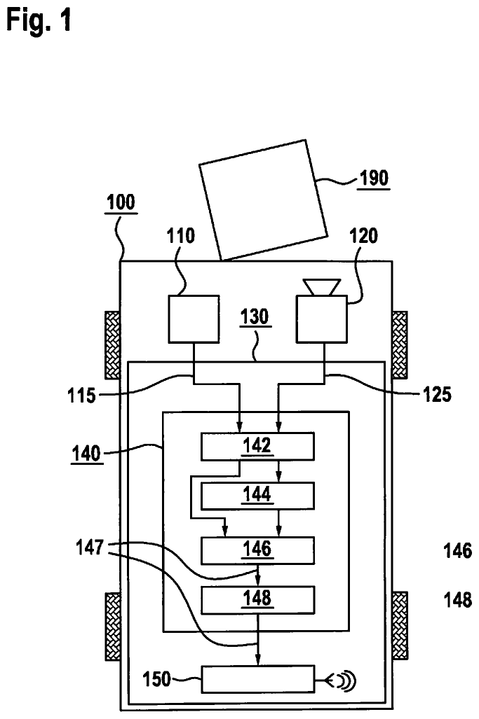

FIG. 1 shows a schematic illustration of a device 140 according to an example embodiment in a vehicle 100 during a collision. Vehicle 100 is a motor vehicle, in particular a land vehicle or road vehicle such as a passenger car or a commercial vehicle. A collision has occurred between vehicle 100 and a merely exemplary collision object 190. Collision object 190, for instance, is another vehicle, a bicyclist, a pedestrian, a stationary obstacle, or the like. Device 140 is configured to generate an emergency call for vehicle 100. Device 140 is developed to generate an emergency call for vehicle 100 in response to the collision.

Only one collision sensor 110, one environment sensor 120, e.g., in the form of a vehicle camera 120, and one emergency-call system 130 including device 140 are shown of vehicle 100 by way of example. Emergency-call system 130 includes device 140 for generating, and a transmitter device 150 for transmitting, the generated emergency call to outside of vehicle 100. Emergency-call system 130 and collision sensor 110 as well as environment sensor 120 are connected to each other in a manner that allows for the transmission of signals.

Collision sensor 110 is developed to detect a collision of vehicle 100 with collision object 190. For example, collision sensor 110 is developed as a pressure sensor, an acceleration sensor, or the like. Collision sensor 110 is developed to output or supply a collision signal 115, which represents at least one collision characteristic of the collision of vehicle 100 with collision object 190.

In the example embodiment shown in FIG. 1, environment sensor 120 is developed as a vehicle camera 120. Environment sensor 120 is developed to detect an environment of vehicle 100. Environment sensor 120 is developed to output or supply an environment-sensor signal 125, which represents an environment of vehicle 100 including the at least one collision object 190.

Device 140 for generating has a read-in device 142, an ascertainment device 144, a generating device 146, and a supply device 148. Device 140 is connected to collision sensor 110, environment sensor 120, and transmitter device 150 in a manner that allows for the transmission of signals.

Read-in device 142 is developed to read in collision signal 115 from an interface to collision sensor 110. Read-in device 142 is also developed to read in environment-sensor signal 125 from an interface to environment sensor 120. In addition, read-in device 142 is developed to forward collision signal 115 to generating device 146 and environment-sensor signal 125 to ascertainment device 144.

According to the example embodiment shown in FIG. 1, read-in device 142 is configured to read in, as environment-sensor signal 125, at least one image signal from an interface to environment sensor 120, which is developed as a vehicle camera. According to another example embodiment, read-in device 142 can be developed to read in a further signal from at least one additional environment sensor as environment-sensor signal 125.

Ascertainment device 144 is developed to ascertain at least one object property of collision object 190 using environment-sensor signal 125. In addition, ascertainment device 144 is developed to forward the at least one ascertained object property to generation device 146 in the form of a signal.

According to the example embodiment shown in FIG. 1, ascertainment device 144 is developed to ascertain the at least one object property as an optically detectable object property using the image signal. Additionally or alternatively, ascertainment device 144 is developed to classify collision object 190 in order to ascertain an object class as the object property.

Generating device 146 is developed to generate an emergency-call signal 147 using the at least one collision characteristic from collision signal 115 and using the at least one object property, which was ascertained using ascertainment device 144. Generated emergency-call signal 147 represents the emergency call for vehicle 100.

According to an example embodiment, generating device 146 is developed to generate an emergency-call signal 147, which represents emergency data that are a function of the at least one collision characteristic and/or the at least one object property. More specifically, generating device 146 is developed to generate an emergency-call signal 147, which represents as the emergency data an estimated value for a number of persons injured by the collision, an estimated value for an injury degree of persons injured by the collision, an estimated value for damage to vehicle 100, and/or an estimated value for damage to the at least one collision object 190.

Supply device 148 is developed to supply generated emergency-call signal 147 for output to transmitter device 150. Transmitter device 150 is developed to transmit emergency-call signal 147 to at least one receiver device outside of vehicle 100. For instance, transmitter device 150 has a radio interface or a similar device for the transmission of emergency-call signal 147.

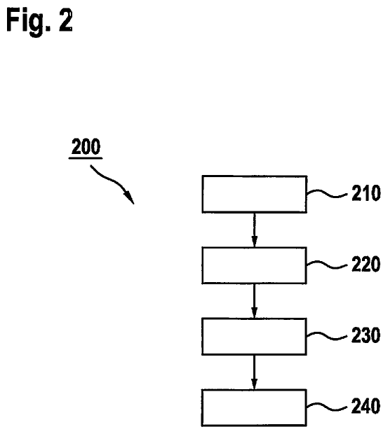

FIG. 2 is a flowchart of a method 200 for generating according to an example embodiment. Method 200 is able to be carried out in order to generate an emergency call for a vehicle. Method 200 for generating can be executed in conjunction with the vehicle from FIG. 1 or a similar vehicle, the emergency-call system from FIG. 1 or a similar emergency call system, and/or the device from FIG. 1 or a similar device. Method 200 for generating is able to be executed using the device from FIG. 1 or a similar device.

In a step 210 of reading in method 200 for generating, a collision signal is read in from an interface to at least one collision sensor of the vehicle and an environment-sensor signal is read in from an interface to at least one environment sensor of the vehicle. The collision signal represents at least one collision characteristic of a collision of the vehicle with at least one collision object. The environment-sensor signal represents an environment of the vehicle, which includes the at least one collision object.

In the following step, using the environment-sensor signal, at least one object property of the at least one collision object is ascertained in a step 220 of ascertaining in method 200 for generating. Then, in a step 230 of generating, an emergency-call signal is generated utilizing the at least one collision characteristic and the at least one object property. Next, in a step 240 of supplying, the emergency-call signal generated in step 230 of generating is made available for output to a transmitter device of the vehicle.

In the following text, application scenarios of example embodiments are summarized and briefly explained in other words with reference to the aforementioned and described figures. During a collision or a crash of vehicle 100 with a bicycle or pedestrian as collision object 190, for example, an emergency-call signal 147 is generated and transmitted, which represents emergency data that allow for the direct alerting of two emergency vehicles and/or two emergency physicians, for example, since damage to collision object 190 that justifies emergency measures can be assumed on the basis of the known ego velocity of vehicle 100 and knowledge of object properties of collision object 190 and also a collision point. In a similar manner, it is possible to estimate possible damage to collision object 190 or an accident opponent based on the collision point and a relative velocity between vehicle 100 and collision object 190.

Using this information as the object property, the arrival of an adequate number of rescue personnel at the accident location is able to be accelerated.

If an example embodiment includes an “and/or” link between a first feature and a second feature, then this should be read to indicate that an example embodiment according to an example embodiment includes both the first feature and the second feature, and according to a further example embodiment, includes either only the first feature or only the second feature.

1-8. (canceled)

9. A method for generating an emergency call for a vehicle, the method comprising:
obtaining a collision signal from an interface to at least one collision sensor of the vehicle and an environment-sensor signal from an interface to at least one environment sensor of the vehicle, the collision signal representing at least one collision characteristic of a collision of the vehicle with at least one collision object, and the environment-sensor signal representing an environment of the vehicle including the at least one collision object;
ascertaining at least one object property of the at least one collision object using the environment-sensor signal;
generating an emergency-call signal using the at least one collision characteristic and the at least one object property; and
supplying the emergency-call signal for output to a transmitter device of the vehicle.

10. The method of claim 9, wherein the emergency-call signal represents emergency data as a function of at least one of the at least one collision characteristic and the at least one object property.

11. The method of claim 9, wherein the emergency-call signal represents at least one of an estimated value for a number of persons injured by the collision, an estimated value of an injury degree of persons injured by the collision, an estimated value of damage to the vehicle, and an estimated value of damage to the at least one collision object.

12. The method of claim 9, wherein the environment-sensor signal is at least one image signal from an interface to a vehicle camera of the vehicle, and the at least one object property is an optically detectable object property.

13. The method of claim 9, wherein the at least one collision object is classified to ascertain an object class as the object property.

14. A device for generating an emergency call for a vehicle, comprising:
a processor;
an input interface; and
an output interface;
wherein the processor is configured to:
obtain, via the input interface and from at least one collision sensor of the vehicle, a collision signal representing at least one collision characteristic of a collision of the vehicle with at least one collision object;
obtain, via the input interface and from at least one environment sensor of the vehicle, an environment-sensor signal representing an environment of the vehicle including the at least one collision object;
ascertain at least one object property of the at least one collision object using the environment-sensor signal;
generate an emergency-call signal using the at least one collision characteristic and the at least one object property; and
supplying the emergency-call signal for output via the output interface to a transmitter device of the vehicle.

15. A non-transitory computer-readable medium on which are stored instructions that are executable by a processor and that, when executed by the processor, cause the processor to perform a method for generating an emergency call for a vehicle, the method comprising:
obtaining a collision signal from an interface to at least one collision sensor of the vehicle and an environment-sensor signal from an interface to at least one environment sensor of the vehicle, the collision signal representing at least one collision characteristic of a collision of the vehicle with at least one collision object, and the environment-sensor signal representing an environment of the vehicle including the at least one collision object;
ascertaining at least one object property of the at least one collision object using the environment-sensor signal;
generating an emergency-call signal using the at least one collision characteristic and the at least one object property; and
supplying the emergency-call signal for output to a transmitter device of the vehicle.
